(19) United States
(12) Patent Application Publication
(10) Pub. No.: US 2014/0242942 A1
(43) Pub. Date: Aug. 28, 2014

(54) OPTIMIZATION OF ONLINE CHARGING TRIGGERS IN COMMUNICATION NETWORKS

(71) Applicants: Uwe Gleinig, Berlin (DE); Gerald Goermer, Wandlitz (DE)

(72) Inventors: Uwe Gleinig, Berlin (DE); Gerald Goermer, Wandlitz (DE)

(73) Assignee: NOKIA SOLUTIONS AND NETWORKS OY, Espoo (FI)

(21) Appl. No.: 14/240,445

(22) PCT Filed: Aug. 25, 2011
(86) PCT No.: PCT/EP2011/064681

§ 371 Date: May 1, 2014

(51) Int. Cl. H04M 15/00

(52) U.S. Cl. CPC H04M 15/885; H04M 15/64; H04M 15/62
USPC 455/406; 455/26.1

(57) ABSTRACT

Devices, methods, and computer program products can comprise a processor module, configured to execute part of an application. The application can be for use in a communication control service. The processor can be configured to store information in a respective data structure (ASI). The device can comprise a transceiver module, configurable to send the respective data structure carrying the service feature execution results, via one of a first and a second interface conforming to different interface protocols. A controller module can block the first of the two interfaces, and is configured, in some cases to control the transceiver module to propagate the respective data structure carrying the information of the service feature execution results via the second interface. When a configuration is not blocking the first interface towards a charging system, the controller module controls the transceiver module so as to transmit the respective data structure towards the charging system.

### FIELD OF THE INVENTION

The present invention relates to optimization of online charging triggers in communication networks, in particular in an IP Multimedia Subsystem (IMS) environment.

### BACKGROUND

Mobile data transmission and data services are constantly making progress. With the increasing penetration of such services, the need for sophisticated charging also increases. Namely, operators need to be able to adequately and granularly charge for the services they provide to the users of the communication system.

The present invention is generally applicable to any communication system in which charging is effected using a charging system such as an online charging system OCS in cooperation with a billing domain, in which such online charging is prepared in a core network (CN) of the communication system.

The following description refers only as a particular example to the IMS core network, though noting that other networks may equally benefit from the present invention when applied thereto. Core networks cooperate with access networks, which finally make services available to the end users using their terminals or user equipments UE. The charging is insofar independent of any access network or access network technology used, and merely depends on the services offered to/subscribed by the end user.

A basic charging architecture is e.g. defined in 3GPP TS 32.260, which gives a detailed definition of elements shown in an architectural overview of FIG. 1 and to which is referred herein. There it is defined an Ro interface (also referred in this specification as first interface hereinafter) as the charging interface between core network elements and the online charging system. It shows only the principle per network element type. A billing domain is connected to an online charging server OCS. The OCS is connected via the Ro interface with various core network elements such as an MRFC, a SIP based application server SIP-AS (more than one SIP-AS are normally present), and, via the intermediary of an IMS gateway IMS-GW, with a serving call state control functionality S-CSCF.

In a real IMS environment, the triggering of the online charging function can be initiated by the CSCF and by multiple additionally involved application servers AS using the Ro interface (i.e. multiple instances of the same element type). Each of these online charging triggers are initiated independent of each other, and may be correlated in the OCS.

FIG. 2 shows a basic IMS architecture for online charging based on the outline shown in FIG. 1. As shown in FIG. 2, a fixed and mobile access network is connected to an IMS core network. The fixed network illustrates terminals such as a PC and wired telephone connected via a BRAS and DSLAM towards the CN. The mobile (or wireless) access network comprises an IMS client such as a so-called user equipment having LTE access (long term evolution, successor of 3GPP) via en evolved Node_B eNB and via a S/P-GW (serving/proxy-Gateway) and a mobility management entity MME towards the CN.

The core network comprises a database known as home subscriber sever HSS, a CSCF and plural application servers AS1, AS2, AS3. The AS are connected via respective SIP interfaces (also referred in this specification as second interface hereinafter) to the CSCF, and the CSCF and the AS are connected to the OCS via a respective Ro I/F.

Using this approach should enable the operator to flexibly design, deploy and orchestrate network services while being not bound to single server technologies nor vendors.

Depending on the number of involved application servers, the basic approach of independent online charging triggers towards the online charging system may, however, lead to a huge amount of parallel online charging triggers for one and the same end-to-end (e2e) use case. Each of these triggers consumes approximately the same amount of resources on the online charging system. In case that one of the major use cases does not generate adequate revenue (e.g. being finally free of charge because of intra-operator-call) the amount of OCS resources to be provided is much higher than compared with former solutions based on intelligent network technology.

In order to alleviate such adverse situation, previously it was attempted to have correlation of the multiple online charging trigger in the OCS based on the following attributes in the online charging trigger message: GGSN-address and IMS-Charging-Identifier. This is standard IMS architecture providing maximum flexibility in distributing the application functionality to several application servers. The disadvantage thereof, however, is that the decision about charging relevance has to be made by the OCS by correlating multiple charging sessions and either terminating all but one charging session or by applying a distributed tariff (i.e. set of independent tariffs; one applied at each charging session).

On the other hand, it was attempted to make use of a general prevention of CSCF charging trigger and involvement of only one application server in the handling of all use cases. This application server is initiating the one and only online charging trigger towards the OCS. The disadvantage thereof, however, is that the flexibility in distributing and combining applications features by using multiple application servers (from potentially multiple vendors) is not given.

Thus, there is still a need to further improve such systems.

### SUMMARY

Various aspects of examples of the invention are set out in the claims.

According to a first aspect of the present invention, there is provided a device, such as a CSCF, which comprises a transceiver module, configurable to send a respective data structure carrying information of service feature execution results, via one of a first (Ro) and a second (SIP) interface conforming to different interface protocols (SIP, DIAMETER), a controller module, configurable to block the first (Ro) of the two interfaces, which interfaces towards a charging system (OCS), and further configured, in case of a configuration blocking the first interface (Ro) towards the charging system (OCS), to control the transceiver module so as to propagate the respective data structure (ASI) carrying the information of the service feature execution results via the second interface (SIP) towards another device (AS, CSCF), or in case of a configuration not blocking the first interface (Ro) towards the charging system (OCS), to control the transceiver module so as to transmit the respective data structure (ASI) carrying the information of the service feature execution results via the first interface (Ro) towards the charging system (OCS)

According to a second aspect of the present invention, there is provided a device such as an application server AS, which comprises a processor module, configured to execute at least one service feature which forms part of an application, the application being set up for a use case in a communication control service, wherein, upon execution of each respective service feature, the processor is configured to generate service feature execution results and to store information associated to those results in a respective data structure (ASI), the service feature execution results being applicable for charging, a transceiver module, configurable to send the respective data structure carrying the information of the service feature execution results, via one of a first (Ro) and a second (SIP) interface conforming to different interface protocols (SIP, DIAMETER), a controller module, configurable to block the first (Ro) of the two interfaces, which interfaces towards a charging system (OCS), and further configured, in case of a configuration blocking the first interface (Ro) towards the charging system (OCS), to control the transceiver module so as to propagate the respective data structure (ASI) carrying the information of the service feature execution results via the second interface (SIP) towards another device (AS, CSCF), or in case of a configuration not blocking the first interface (Ro) towards the charging system (OCS), to control the transceiver module so as to transmit the respective data structure (ASI) carrying the information of the service feature execution results via the first interface (Ro) towards the charging system (OCS).

Advantageous further developments thereof are set out in the dependent claims.

Further, according to third aspect, there are provided corresponding methods carried our by those devices, namely,

a method, comprising: sending, by a transceiver module, a respective data structure carrying information of service feature execution results, via one of a first (Ro) and a second (SIP) interface conforming to different interface protocols (SIP, DIAMETER), blocking or not blocking, by a controller module, the first (Ro) of the two interfaces, which interfaces towards a charging system (OCS), and further, in case of a configuration blocking the first interface (Ro) towards the charging system (OCS), controlling the transceiver module so as to propagate the respective data structure (ASI) carrying the information of the service feature execution results via the second interface (SIP) towards another device (AS, CSCF), or in case of a configuration not blocking the first interface (Ro) towards the charging system (OCS), controlling the transceiver module so as to transmit the respective data structure (ASI) carrying the information of the service feature execution results via the first interface (Ro) towards the charging system (OCS);
as well as
a method, comprising: executing, by a processor module, at least one service feature which forms part of an application, the application being set up for a use case in a communication control service, and upon execution of each respective service feature, generating, by the processor module, service feature execution results and storing information associated to those results in a respective data structure (ASI), the service feature execution results being applicable for charging, sending, by a transceiver module, the respective data structure carrying the information of the service feature execution results, via one of a first (Ro) and a second (SIP) interface conforming to different interface protocols (SIP, DIAMETER), blocking or not blocking, by a controller module, the first (Ro) of the two interfaces, which interfaces towards a charging system (OCS), and further, in case of a configuration blocking the first interface (Ro) towards the charging system (OCS), controlling the transceiver module so as to propagate the respective data structure (ASI) carrying the information of the service feature execution results via the second interface (SIP) towards another device (AS, CSCF), or in case of a configuration not blocking the first interface (Ro) towards the charging system (OCS), controlling the transceiver module so as to transmit the respective data structure (ASI) carrying the information of the service feature execution results via the first interface (Ro) towards the charging system (OCS).

Advantageous further developments thereof are set out in the dependent claims.

According to a fourth aspect of the present invention, there is provided a computer program product comprising computer-executable components which, when the program is run on a computer, are configured to implement the respective methods mentioned above. The above computer program product may further comprise computer-executable components which, when the program is run on a computer, perform the method aspects mentioned above in connection with the method aspects. The above computer program product/products may be embodied as a computer-readable storage medium.

Thus, performance improvement is based on above methods, devices and computer program products. In particular,
the trigger signals towards the OCS are significantly reduced in number,
the interfaces used towards the OCS are significantly reduced in number, preferably only a single interface Ro from an AS or CSCF is carrying the information to the OCS,
compatibility to existing scenarios is preserved due to used/re-used data formats,
flexibility is preserved due to various configuration possibilities,
processing load imposed on the OCS is reduced in terms of correlation processing f multiple charging sessions, etc.

### BRIEF DESCRIPTION OF DRAWINGS

For a more complete understanding of example embodiments of the present invention, reference is now made to the following descriptions taken in connection with the accompanying drawings in which:

FIG. 1 shows a charging architecture as e.g. defined in 3GPP TS 32.260;

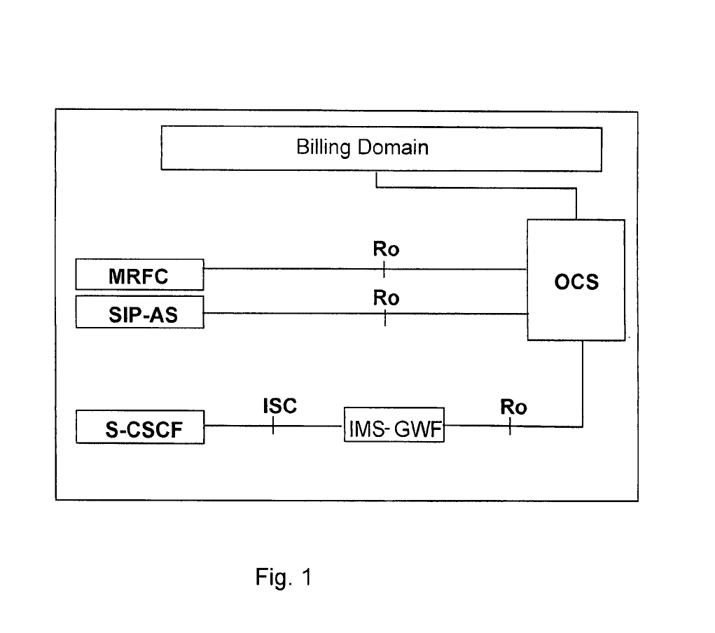

FIG. 2 shows a basic IMS architecture for online charging based on the outline shown in FIG. 1;

FIG. 3 shows procedural elements of aspects of the invention in an architecture depicted in FIG. 2;

FIG. 4 shows an exemplary embodiment adopting triggering of the charging towards the OCS by the last involved AS (local configuration);

FIG. 5 shows an exemplary embodiment adopting triggering of the charging towards the OCS by the S-CSCF after the last AS has been involved;

FIG. 6 shows an exemplary embodiment adopting triggering of the charging towards the OCS by the S-CSCF before the first AS will be involved; collection of ASI after the last AS has been involved (change in rating conditions); and

FIG. 7 shows an exemplary embodiment adopting triggering of the charging towards the OCS by an intermediate AS and by the S-CSCF after the last AS has been involved to collect not yet signalled ASI.

### DESCRIPTION OF EXEMPLARY EMBODIMENTS

Exemplary aspects of the invention will be described herein below.

Generally, the invention is implemented in a core network element such as a CSCF or an application server AS, i.e. in a control module thereof controlling a transceiver module of the device in terms of transmitting and/or receiving information to/from other devices.

For the subsequent description, it is worth noting that a use case as denoted in this specification denotes fort example a phone call or other end-to-end use case. As a part of such a phone call, an application such as a VPN (virtual private network) application may be run. The application as such can be distributed in terms of execution over more than one application servers AS. An application server in turn is in charge of one or more service features which, together, constitute the application. For example, a VPN can be constructed out of several features like PrivateNumberingPlan (PNP) which is doing a number translation and is determining, if the destination number is part of this private numbering plan or not. There may be another e.g. time based screening feature which is determining at which time windows the call is a company call and at which time windows the user has to consider it as a private call. Both features are known as “service features or components” report its results in separate data structures carrying information of service feature execution results, i.e. AVP-instances. Namely, one for the PNP reporting about the on-net/off-net and the translated number, and one for the screening reporting about the private/company result such as “private number”, “number screening”.

At least application servers, optionally also a CSCF, has a processor module configured to execute at least one service feature which forms part of an application, the application being set up for a use case in a communication control service. Upon execution of each respective service feature, the processor is configured to generate service feature execution results and to store information associated to those results in a respective data structure, the service feature execution results being applicable for charging.

Generally, in the subsequent description, when referring to specific structures, it is to be noted that the individual element names or the like are only examples. That is, as long as serving for the same purpose and/or reflecting the same structure, the elements, parameters, attributes or the like could also have other names.

Briefly stated, accordingly to an exemplary feature of the present invention, it is proposed to accumulate all charging relevant information of all distributed service features (or components) into one single or optionally multiple charging trigger.

The container of this information on the IMS-Ro interface (which operates based on the DIAMETER protocol) is provided by a standardized structured AVP application-server-information [defined in 3GPP TS 32.299] which convey, for each service feature individually, all service information which are relevant for the OCS in a separate instance of this structured AVP.

### -Application-Server-Information AVP (ASI-AVP)

The Application-Server-Information AVP (AVP code 850) is of type Grouped and contains information about application servers visited through ISC interface.

It has the following ABNF grammar:

<Application-Server-Information>::= <AVP Header: 850 >
[ Application-Server ]
* [ Application-Provided-Called-Party-Address]

Those two fields of the ASI will be detailed further below.

The content of this ASI-AVP may preferably, as an option to improve compatibility, be structured according to an existing specification.

### -Application-Server-AVP

The Application-Server AVP (AVP code 836) is of type UTF8String and holds the SIP URL(s) of the AS(s) addressed during the session.

The SIP-URI within this AVP shall provide an identification of a particular service feature of a service and shall also provide their processing results, which may be relevant for rating and charging, as a set of appended parameters following the syntax definition in RFC 3261. The number, names values of the parameters are not restricted.

The (content) structure can be as follows:
<version>.<service-feature>@<server>.<operator>.<country>; attribute1=value1; attribute2=value2; booleanattribute1

Therein, “service-feature” denotes a service feature forming part of an application, “attribute1”, “attribute2” and “booleanattributel” being attributes/parameters and values denoting the respective result of the executed service feature.

It is noted that such structure could also be different in that, for example, a different number of attributes and/or booleanattributes is applied, or the like.

Generally, the parameters and attributes in such structure could generally be in accordance with 3GPP TS32.299 and/or RFC3261.

For example, such structure could be applicable as follows:
2.vpn@AS5. mobileX.de; calltype=onnet
   where 2 represents an example of a version, vpn represents an example of a service feature, AS5 represents an example of a server, mobileX represents an example of an operator, de (standing for Germany) represents an example of a country, and calltype represents an example of an attribute exemplarily having the value “onnet”.

### -Application-Provided-Called-Party-Address-AVP

The Application-Provided-Called-Party-Address AVP (AVP code 837) is of type UTF8String and holds the called party number (SIP URI, E.164), if it is determined by an application server.

This parameter shall contain a destination address determined by the service feature identified in the Application-Server AVP if the address is different than the original destination address. If there are multiple addresses as a result of the processing of this service feature, multiple instances of this AVP, each containing one destination address, shall be used. Also here, leg specific processing results, which may be relevant for rating and charging, can be appended in the SIP-URI or TEL-URI parameter list.

An example could be
“tel:+493047110815; rn=D435”
   where the leg specific porting information is appended as a parameter to the destination number itself.

The definition of the Tel-URI could generally be in accordance with RFC3966.

Such ASI-AVP is configured to be transmitted via the Ro I/F using DIAMETER protocol.

Further, according to an exemplary aspect of the invention, it is decided by the S-CSCF and each AS to prevent an own charging trigger (otherwise sent via Ro I/F to the OCS) and instead to propagate the charging relevant service information of each service component in the outgoing SIP message towards the S-CSCF. In such scenario, the ASI-AVP (designed for DIAMETER on Ro) needs to be carried/conveyed to the SIP based interface between AS and CSCF. To assure compatibility, the structure of the ASI-AVP is beneficially also maintained on the second interface (SIP based).

In terms of the charging-trigger-suppression function on each network element, it is to be noted that since the triggering of the online charging is not configurable in the HSS for each AS individually, there must be a local functionality on the S-CSCF and on each AS to decide, if online charging shall be triggered via Diameter (via Ro I/F) or not. This decision shall be based on a set of suppression-rules each consisting of a set of flexible configurable criteria. Criteria can be: AS-Request-URI, SIP-Method, AS-Role-of-node, AS-origIP, . . . , i.e. for the charging suppression on each network element, criteria can be configured and chosen per service feature, per application or even by use case, so as to define which NE is triggering the charging function.

And, the information shall in this regard be conveyed within a new P-charging-vector header element application-server-information having the same structure as the AVP on the Ro interface to provide the same set of functionality on the SIP based I/F.

In this regard, the following structure is applicable:
as-charging-information=*(application-server-information) application-server-information=(application-server*(SEMI application-provided-called-party-address)) application-server=“ims-as” EQUAL quoted-string application-provided-called-party-address=“as-cdpa” EQUAL quoted-string

Each AS should also be aware of such charging relevant service information provided in the SIP message received from a preceding AS (via the S-CSCF) and shall add also this information to the outgoing SIP message if this AS is not triggering the OCS itself.

Generally, the (content) structure can be as follows:

<version>.<service-feature>@<server>.<operator>.<country>; attribute1=value1; attribute2=value2; booleanattribute1

Therein “service-feature” denotes a service feature forming part of an application, “attribute1”, “attribute2” and “booleanattributel” being attributes/parameters and values denoting the respective result of the executed service feature.

It is noted that such structure could also be different in that, for example, a different number of attributes and/or booleanattributes is applied, or the like.

An example for the application-server P-charging-vector element could be applicable as follows:
2.vpn@AS5.mobileX.de; calltype=onnet,
   where 2 represents an example of a version, vpn represents an example of a service feature, AS5 represents an example of a server, mobileX represents an example of an operator, de (standing for Germany) represents an example of a country, and calltype represents an example of an attribute exemplarily having the value “onnet”.

As evident from the above, the structure of the content of these elements shall be equivalent to (i.e. the same or similar as) those used on the Ro (DIAMETER) interface. Thereby, it may be facilitated that no intermediate processing is to be enforced to have any knowledge about the semantic thereof. Rather, it may thus be sufficient to only copy the content to the corresponding attributes of the outgoing message within the equivalent structure.

The format of the Application-Provided-Called-Party-Address may be a normal TEL-URI or a normal SIP-URI. Note that also in these URIs the address information may be succeeded by a list of parameters (i.e. “rating relevant service feature information” or the like). An example of an accumulated ASI message via SIP based I/F from and AS towards the CCG or from a CSCF towards an AS could be as follows:

An example of a P-chg-vector-ASI could be as follows:

application-server=2.vpn@AS5.mobileX.de; calltype=onnet
application-provided-called-party-address=“tel:+493047110815; rn=D435”
application-server=1.parallelringing@AS7.mobileX.de
application-provided-called-party-address=“tel:+493047110815; rn=D435”
application-provided-called-party-address=tel:+493047110816; rn=D435”
application-provided-called-party-address=“tel:+493047110817; rn=D435”
application-server=“1.screening@AS1.mobileX.de; category=verified”

Thus, in the above example, messages from three application servers, AS5, AS7, and AS1 are accumulated in a single message, and relating to different service features, i.e. vpn, parallel_ringing and screening, respectively, together with the results of service feature execution being reflected/inserted in the defined attribute structure.

The implementation on OCS preferably relies on such content-structure, and in connection with the present invention, that information in the P-charging-vector-ASI-elements (in SIP I/F) are 1:1 transferred towards Ro-ASI-elements (carried based on DIAMETER on Ro I/F), and the other way round: Information in the P-chg-vect-ASI-elements should be the same “as it would have been put to Ro-ASI” if the NE would have raised the charging trigger by itself if not prevented therefrom.

Thus, in line with at least an exemplary aspect of the invention, a CSCF and AS is provided with a transceiver module, configurable to send the respective data structure carrying the information of the service feature execution results, via one of a first (Ro) and a second (SIP) interface conforming to different interface protocols (SIP, DIAMETER), and provided with a controller module, configurable to block the first (Ro) of the two interfaces, which interfaces towards a charging system (OCS), and the controller module is also configured, in case of a configuration blocking the first interface (Ro) towards the charging system (OCS), to control the transceiver module so as to propagate the respective data structure (ASI) carrying the information of the service feature execution results via the second interface (SIP) towards another device (AS, CSCF), or in case of a configuration not blocking the first interface (Ro) towards the charging system (OCS), to control the transceiver module so as to transmit the respective data structure (ASI) carrying the information of the service feature execution results via the first interface (Ro) towards the charging system (OCS).

The charging trigger can be initiated by the CSCF and/or by any application server in any combination. In order to optimize the number of charging triggers, preferably only one element is initiating the charging trigger. Each network element (CSCF/AS) which is initiating a charging trigger, shall provide all charging relevant service information from all service components either received via the incoming SIP message or generated by service components on the triggering application server in the charging request message in separate instances (one per service component) of the AVP application-server-information towards the OCS. Each information element which has been propagated towards the OCS via Ro interface shall be removed from the P-charging-vector header of the SIP message outgoing on the SIP based I/F towards the CSCF for being propagated to another AS.

In order to ensure this charging relevant information to be trusted information of the charging domain of a particular operator, according to another exemplary feature, it is removed at the inbound border of this domain, i.e. either the P-CSCF or in case of roaming scenarios the I-CSCF provides such a filter mechanism.

Exemplary embodiments will be briefly described with reference to the drawings.

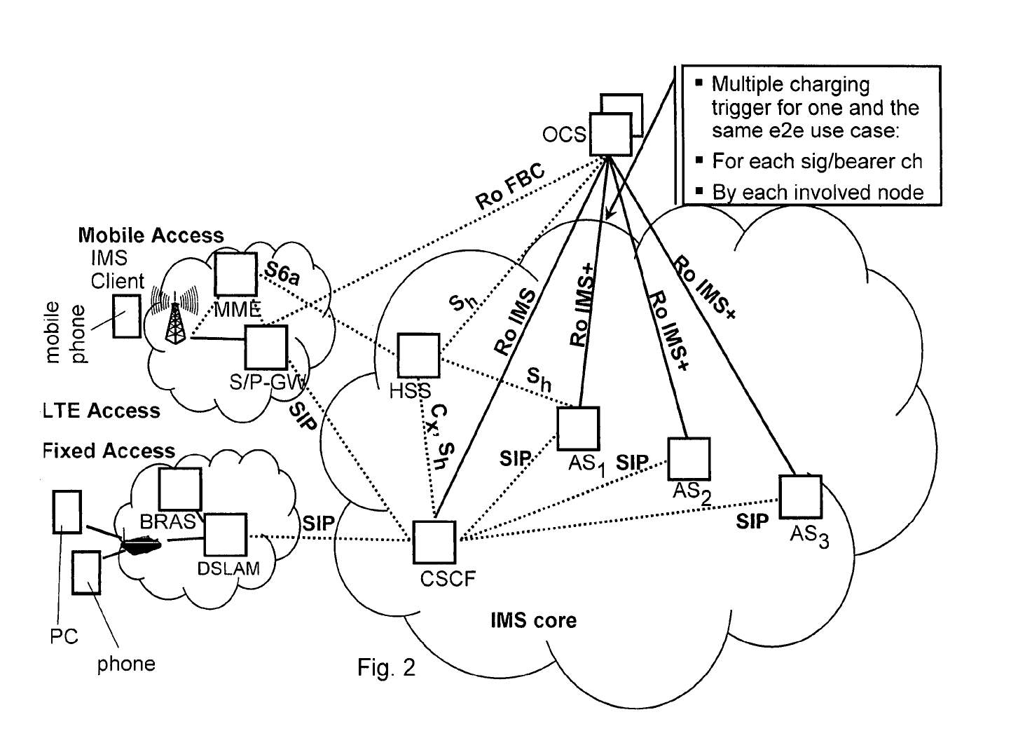

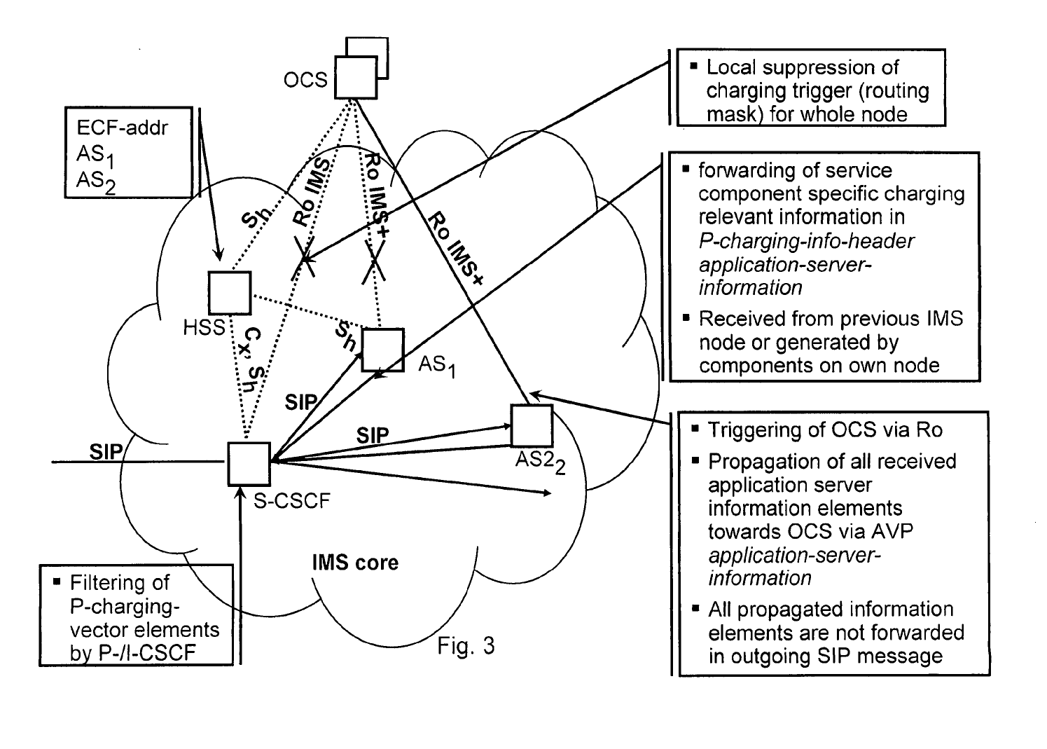

FIG. 3 shows procedural elements of aspects of the invention in an architecture depicted in FIG. 2. As shown, S-CSCF and AS1 are locally configured so as to block the first interface (Ro) towards the charging system (OCS). Instead, they are configured to control the transceiver module so as to propagate the respective data structure (ASI) carrying the information of the service feature execution results via the second interface (SIP) towards another device (AS, CSCF). I.e. AS1 sends its ASI data to the S-CSCF, which sends it further to AS2. I.e., the transceiver modules of 5-CSCF and As2 are respectively configured to receive a respective data structure (ASI) carrying the information of the service feature execution results via the second interface (SIP) from another device (AS1 for S-CSCF, and S-CSCF for AS2). AS2, in turn, has a configuration of not blocking the first interface (Ro) towards the charging system (OCS), and is this controlled in terms of its transceiver module so as to transmit the respective (here already accumulated) data structure (ASI) carrying the information of the service feature execution results via the first interface (Ro) towards the charging system (OCS).

Thus, S-CSCF and AS1 feature local suppression of charging trigger (routing mask) for whole node towards the OCS. AS1 features forwarding of service component specific charging relevant information in P-charging-info-header application-server-information (via SIP based I/F) (potentially also received from previous IMS node) or, as shown, generated by service features/components on its own node. And AS2, in turn features triggering of OCS via Ro and also the propagation of all received application server information elements towards OCS via AVP application-server-information (DIAMETER based on Ro I/F). All propagated information elements are not forwarded any more in any outgoing SIP message. And, the S-CSCF (acting as P-/I-CSCF) further features a filtering of P-charging-vector elements.

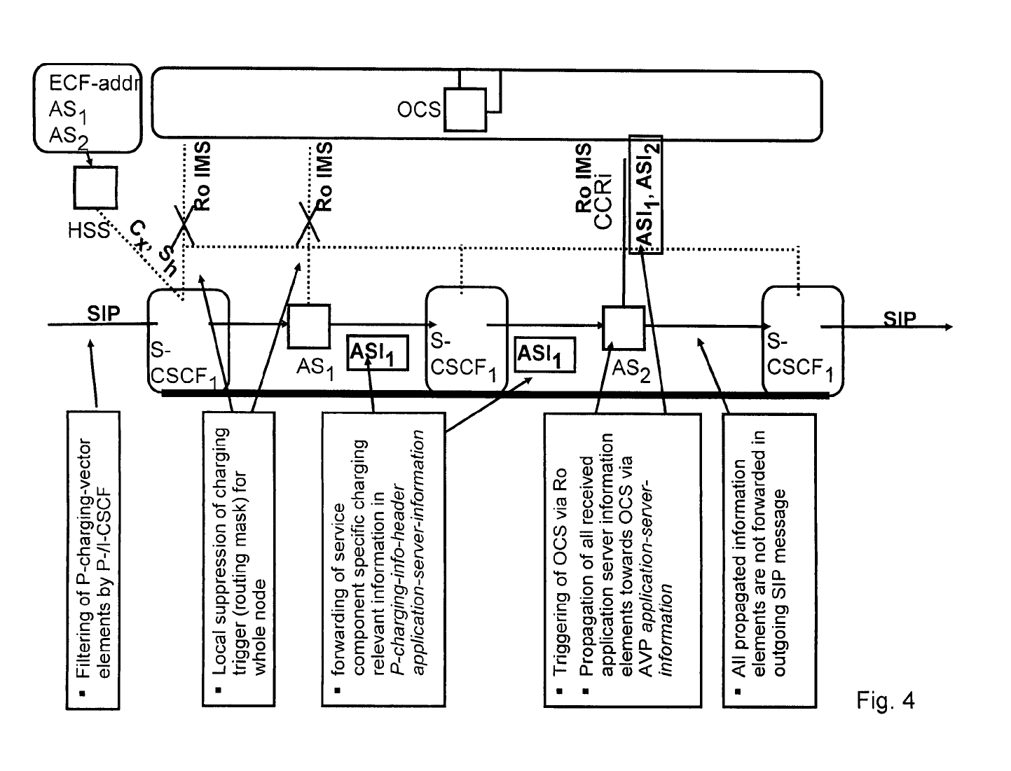

In FIGS. 4 to 7, the S-CSCF is illustrated plural times per Figure to reflect that data transmission is routed repeatedly via the S-CSCF when conveyed to/from an AS. In horizontal direction, the SIP based I/F's are shown, while in vertical direction (towards the OCS) the DIAMETER based RO interface(s) is(are) shown.

FIG. 4 thus shows an exemplary embodiment adopting triggering of the charging towards the OCS by the last involved AS (local configuration). That is, only AS2 transmits the ASI1 (generated at AS1 and propagated from AS1 via the S-CSCF) to the AS2 and the ASI2 generated at AS2 to the OCS. ASI1 and ASI2 denote a respective data structure carrying information of service feature execution results, via one of a first (Ro) and a second (SIP) interface conforming to different interface protocols (SIP, DIAMETER). Implemented features are thus similar and conformant to those explained with reference to FIG. 3 in another more general graphical representation.

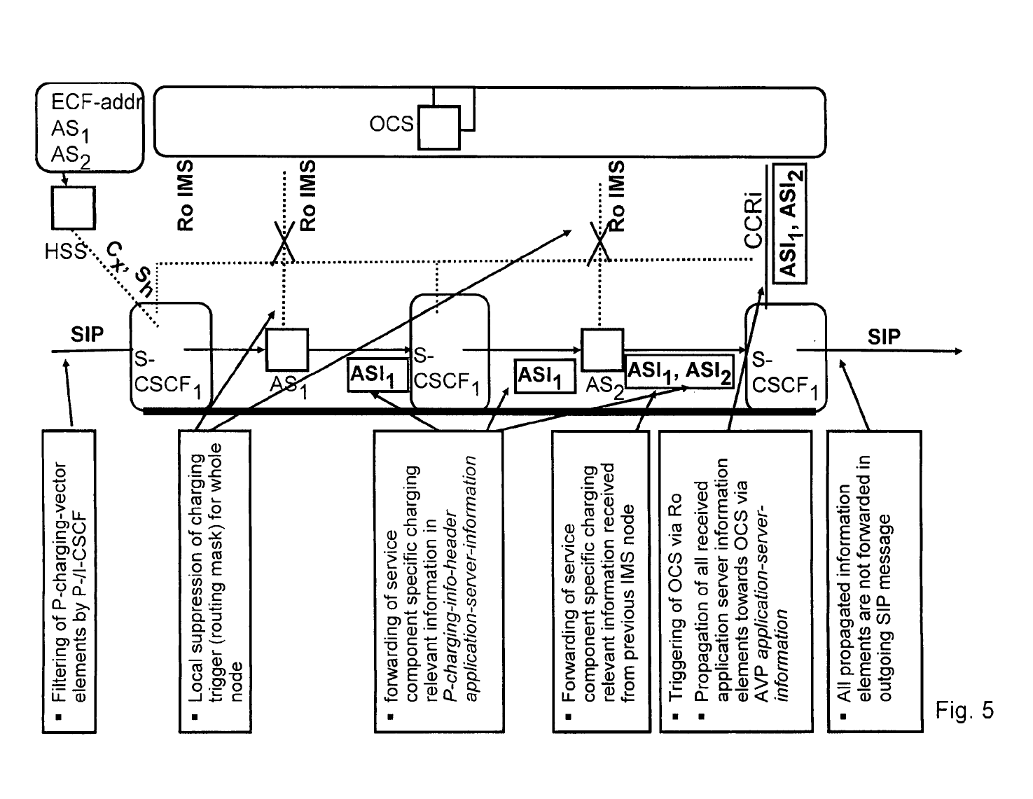

FIG. 5 shows an exemplary embodiment adopting triggering of the charging towards the OCS by the S-CSCF after the last AS has been involved. That is, only S-CSCF transmits the ASI1 (generated at AS1 and propagated from AS1 via the S-CSCF to the AS2 and again to the S-CSCF), and the ASI2 generated at AS2 and propagated to the S-CSCF to the OCS. ASI1 and ASI2 denote a respective data structure carrying information of service feature execution results, via one of a first (Ro) and a second (SIP) interface conforming to different interface protocols (SIP, DIAMETER). Implemented features are thus similar and conformant to those explained with reference to FIG. 3 in another more general graphical representation.

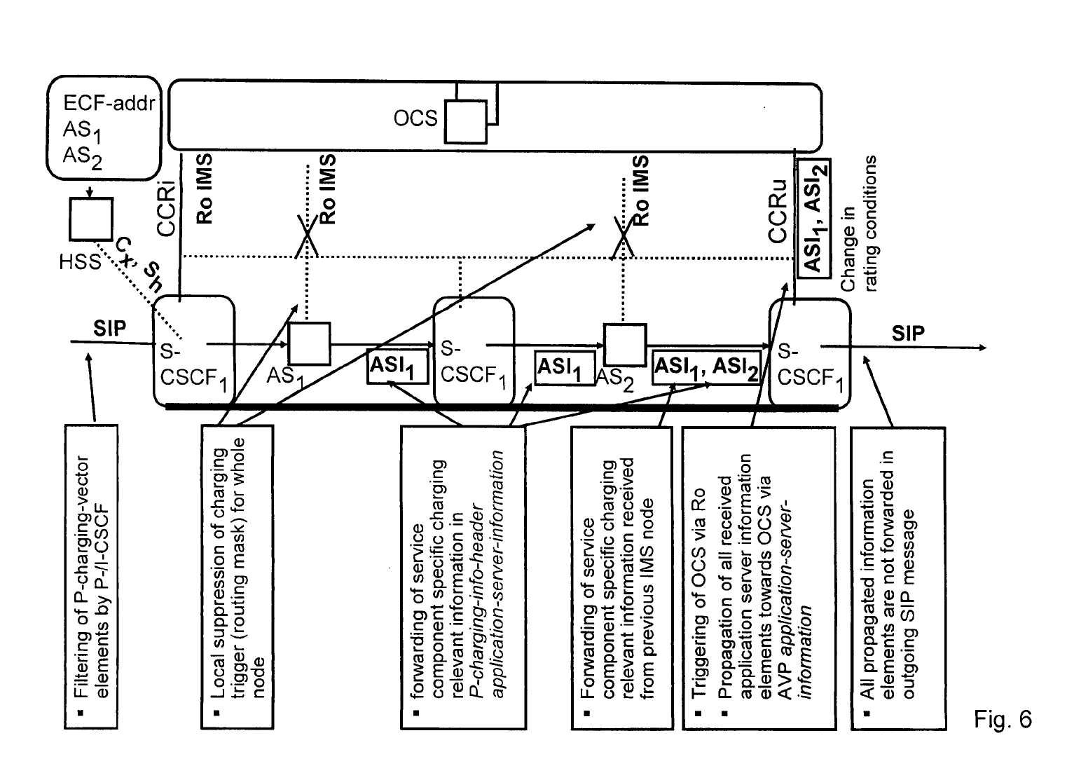

FIG. 6 shows an exemplary embodiment adopting triggering of the charging towards the OCS by the S-CSCF before the first AS will be involved; collection of ASI after the last AS has been involved (change in rating conditions). The scenario is similar to the one shown in FIG. 5 with the difference that an initial CCRi message is sent from the S-CSCF (configured as not blocking the Ro I/F) and that an update CCRu message is sent from S-CSCF after the last AS has been involved. AS1 and AS2 are configured to block Ro I/F.

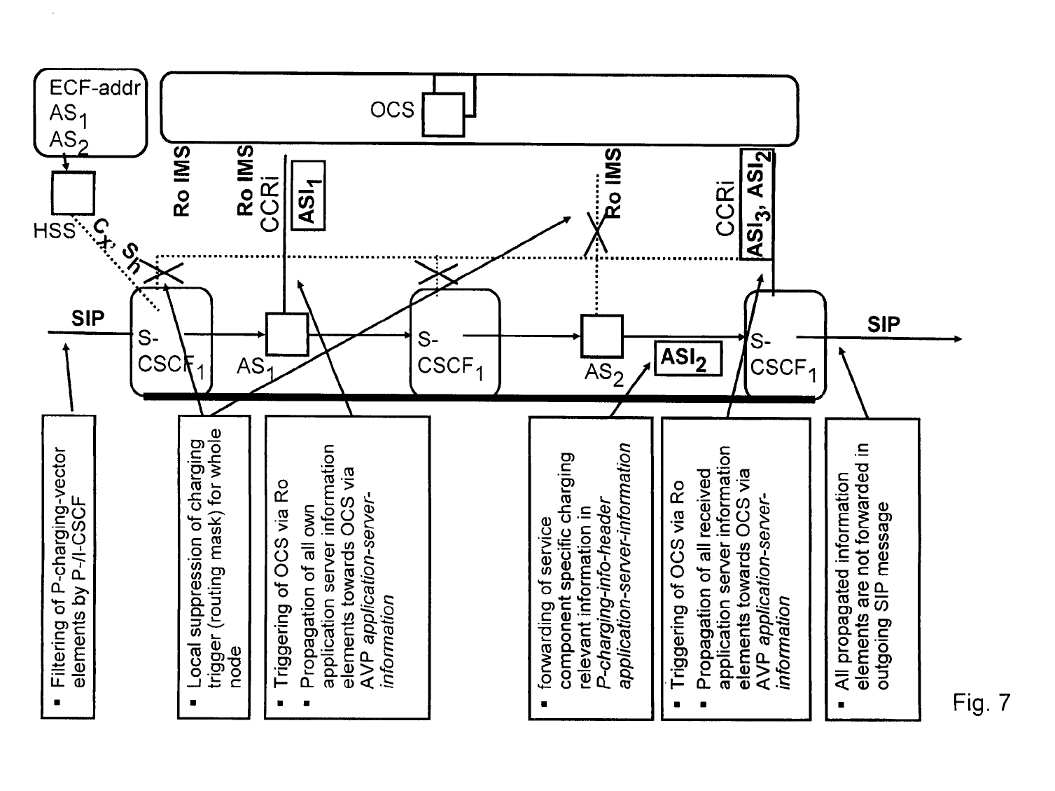

FIG. 7 shows an exemplary embodiment adopting triggering of the charging towards the OCS by an intermediate AS and by the S-CSCF after the last AS has been involved to collect not yet signalled ASI. The scenario is similar to the one shown in FIG. 6 with the difference that an initial CCRi message is sent from the AS1 and sending ASI1 information to the OCS (which is then not propagated an more to the S-CSCF and/or AS2) and that an update CCRu message is sent from the S-CSCF after the last AS, i.e. AS2 has been involved. The S-CSCF then sends information that has not been sent to the OCS, i.e. ASI3 and ASI2, ASI2 generated at the AS2 and propagate via SIP based I/F to the S-CSCF and ASI3 generated at the S-CSCF. Thus, initially S-CSCF is configured to block the Ro I/F and AS1 is configured not to block that I/F, and finally, S-CSCF is released from blocking the Ro I/F after the last AS was involved. Insofar, the controller module of the S-CSCF is configured to detect that the device is the last device in the sequence, and responsive thereto, to control the transceiver module so as to transmit those respective data structures (ASI) received from another device and those generated at the device itself, via the first interface (Ro) towards the charging system (OCS), irrespective of a configuration blocking the first interface (Ro).

In such case, the device (or the controller module of the AS/S-CSCF) may be further configured to carry out a call supervision or the like. Such call supervision or the like is based on the fact that the device represents the partner of the charging system, and serves for handling charging issues with respect to the OCS.

Further, the device (or the controller module of the S-CSCF) may be aware of a sequence of other devices involved in the use case or a number and sequence of other devices involved in the use case, to which to propagate the respective data structure (ASI) or from which to receive the respective data structure (ASI).

Thus, in scenarios shown in FIGS. 4 and 5, the last involved network element NE is initiating the charging trigger, while in FIGS. 6 and 7, the first involved NE is initiating the charging trigger towards the OCS.

Other systems can benefit also from the principles presented herein as long as they have identical or similar properties like an OCS and core network entities supporting charging functions of the OCS.

With the presented solution being used, it is deployed in connection with an online charging system installed in an IMS network. This online charging system then has an interface to only one element of the IMS core network (i.e. CSCF or IMS-AS) per use case. That is, trigger signals towards the OCS are reduced in number, preferably down to only one trigger. Use of the invention implies that the application-server-information AVP is heavily used related to services not residing on the triggering core network element on the Ro interface, i.e. the AVPs transmitted from a triggering element have an origin different from the triggering element as they are sent only after having been accumulated. On the SIP interfaces, proprietary information between IMS core network elements can be exchanged.

Embodiments of the present invention may be implemented in software, hardware, application logic or a combination of software, hardware and application logic. The software, application logic and/or hardware generally resides on control modules and/or transceiver modules.

In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as core network node like an application server AS or a node in charge of call control services such as a CSCF.

The present invention relates in particular but without limitation to mobile communications, for example to IMS environments and can advantageously be implemented in servers and nodes connectable to such networks. That is, it can be implemented as/in chipsets to connected devices, and/or modules thereof, in particular to current and future (next generation) application servers AS and CSCF entities.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

The present invention proposes devices, some of which comprise a processor module, configured to execute at least one service feature which forms part of an application, the application being set up for a use case in a communication control service, wherein, upon execution of each respective service feature, the processor is configured to generate service feature execution results and to store information associated to those results in a respective data structure (ASI), the service feature execution results being applicable for charging, and all of which comprise a transceiver module, configurable to send the respective data structure carrying the information of the service feature execution results, via one of a first (Ro) and a second (SIP) interface conforming to different interface protocols (SIP, DIAMETER), a controller module, configurable to block the first (Ro) of the two interfaces, which interfaces towards a charging system (OCS), and further configured, in case of a configuration blocking the first interface (Ro) towards the charging system (OCS), to control the transceiver module so as to propagate the respective data structure (ASI) carrying the information of the service feature execution results via the second interface (SIP) towards another device (AS, CSCF), or in case of a configuration not blocking the first interface (Ro) towards the charging system (OCS), to control the transceiver module so as to transmit the respective data structure (ASI) carrying the information of the service feature execution results via the first interface (Ro) towards the charging system (OCS). Apart from the devices, corresponding methods and computer program products are concerned.

### LIST OF ABBREVIATIONS

| | |
|---|---|
| OCS | online charging system |
| CSCF | Call Session Control Function |
| S-CSCF | Serving CSCF |
| P-CSCF | Proxy CSCF |
| I-CSCF | Interrogating CSCF |
| IMS | IP Multimedia Subsystem |
| AS | Application Server |
| ASI | Application-server-information (AVP) |
| AVP | Attribute value pair (attributes in Diameter) |

MRFC: Media Resource Function Controller
BRAS: Broadband Remote Access Server
DSLAM: Ddigital Subscriber Line Access Multiplexer
ISC: IMS service control, see TS 24.229
ABNF: Angereicherte Bachus Naur Form, see RFC 5234 for english definition of ABNF
NGIN: Next Generation Intelligent Network
MNP: Mobile Number Portability
CCRi: Credit Control Request initial
CCRu: CCR update
CCA: Credit Control Answer

1. A device, comprising
a transceiver module, configurable to send a respective data structure carrying information of service feature execution results, via one of a first and a second interface conforming to different interface protocols,
a controller module, configurable to block the first of the two interfaces, which interfaces towards a charging system, and
further configured,
in case of a configuration blocking the first interface towards the charging system, to control the transceiver module so as to propagate the respective data structure carrying the information of the service feature execution results via the second interface towards another device, or
in case of a configuration not blocking the first interface towards the charging system, to control the transceiver module so as to transmit the respective data structure carrying the information of the service feature execution results via the first interface towards the charging system.

2. A device, comprising
a processor module, configured to execute at least one service feature which forms part of an application, the application being set up for a use case in a communication control service,
wherein, upon execution of each respective service feature, the processor is configured to generate service feature execution results and to store information associated to those results in a respective data structure (ASI), the service feature execution results being applicable for charging,
a transceiver module, configurable to send the respective data structure carrying the information of the service feature execution results, via one of a first and a second interface conforming to different interface protocols,
a controller module, configurable to block the first of the two interfaces, which interfaces towards a charging system, and
further configured,
in case of a configuration blocking the first interface towards the charging system, to control the transceiver module so as to propagate the respective data structure carrying the information of the service feature execution results via the second interface towards another device, or
in case of a configuration not blocking the first interface towards the charging system, to control the transceiver module so as to transmit the respective data structure carrying the information of the service feature execution results via the first interface towards the charging system.

3. A device according to claim 1, wherein
the transceiver module is further configured to receive a respective data structure carrying the information of the service feature execution results via the second interface from another device.

4. A device according to claim 3, wherein
the controller module is configured, in case of a configuration blocking the first interface towards the charging system, to control the transceiver module so as to propagate those respective data structures received from another device and those generated at the device itself, towards another device via the second interface.

5. A device according to claim 3, wherein
the controller module is configured, in case of a configuration not blocking the first interface towards the charging system, to control the transceiver module so as to transmit those respective data structures received via the second interface from another device and those generated at the device itself, towards the charging system via the first interface.

6. A device according to claim 1, wherein
the controller module is locally configurable to block the first of the two interfaces, which interfaces towards a charging system, based on a set of suppression-rules each consisting of a set of configurable criteria which are selectable per service feature, per application, or per use case.

7. A device according to claim 1, wherein
the controller module is aware of a sequence of other devices involved in the use case, to which to propagate the respective data structure or from which to receive the respective data structure.

8. A device according to claim 1, wherein
the controller module is configured to detect that the device is the last device in the sequence, and responsive thereto, to control the transceiver module so as to transmit those respective data structures received from another device and those generated at the device itself, via the first interface towards the charging system, irrespective of a configuration blocking the first interface.

9. A method, comprising:
sending, by a transceiver module, a respective data structure carrying information of service feature execution results, via one of a first and a second interface conforming to different interface protocols,
blocking or not blocking, by a controller module, the first of the two interfaces, which interfaces towards a charging system, and
further,
in case of a configuration blocking the first interface towards the charging system, controlling the transceiver module so as to propagate the respective data structure carrying the information of the service feature execution results via the second interface towards another device, or
in case of a configuration not blocking the first interface towards the charging system, controlling the transceiver module so as to transmit the respective data structure carrying the information of the service feature execution results via the first interface towards the charging system.

10. A method, comprising
executing, by a processor module, at least one service feature which forms part of an application, the application being set up for a use case in a communication control service, and
upon execution of each respective service feature, generating, by the processor module, service feature execution results and storing information associated to those results in a respective data structure, the service feature execution results being applicable for charging,
sending, by a transceiver module, the respective data structure carrying the information of the service feature execution results, via one of a first and a second interface conforming to different interface protocols,
blocking or not blocking, by a controller module, the first of the two interfaces, which interfaces towards a charging system (OCS), and
further,
in case of a configuration blocking the first interface towards the charging system, controlling the transceiver module so as to propagate the respective data structure carrying the information of the service feature execution results via the second interface towards another device, or
in case of a configuration not blocking the first interface towards the charging system, controlling the transceiver module so as to transmit the respective data structure carrying the information of the service feature execution results via the first interface towards the charging system.

11. A method according to claim 9, further comprising
receiving, by the transceiver module, a respective data structure carrying the information of the service feature execution results via the second interface from another device.

12. A method according to claim 11, further comprising
in case of a configuration blocking the first interface towards the charging system, controlling the transceiver module so as to propagate those respective data structures received from another device and those generated at the device itself, towards another device via the second interface.

13. A method according to claim 11, further comprising
in case of a configuration not blocking the first interface towards the charging system, controlling the transceiver module so as to transmit those respective data structures received via the second interface from another device and those generated at the device itself, towards the charging system (OCS) via the first interface.

14. A method according to claim 9, further comprising
locally configuring the controller module to block the first of the two interfaces, which interfaces towards a charging system, the configuring being based on a set of suppression-rules each consisting of a set of configurable criteria which are selectable per service feature, per application, or per use case.

15. A method according to claim 9, wherein
the controller module is aware of a sequence of other devices involved in the use case, to which to propagate the respective data structure or from which to receive the respective data structure.

16. A method according to claim 9, further comprising
detecting, by the controller module, that the device is the last device in the sequence, and responsive thereto, controlling the transceiver module so as to transmit those respective data structures received from another device and those generated at the device itself, via the first interface towards the charging system, irrespective of a configuration blocking the first interface.

17. A computer program product comprising computer-executable components embodied on a non-transitory computer-readable medium which, when the program is run on a computer, are configured to execute the method according to claim 9.

18. A computer program product comprising computer-executable components embodied on a non-transitory computer-readable medium which, when the program is run on a computer, are configured to execute the method according to claim 10.

19. A computer program product comprising computer-executable components embodied on a non-transitory computer-readable medium which, when the program is run on a computer, are configured to execute the method according to claim 11.

20. A computer program product comprising computer-executable components embodied on a non-transitory computer-readable medium which, when the program is run on a computer, are configured to execute the method according to claim 12.
